(19) United States
(12) Patent Application Publication
(10) Pub. No.: US 2019/0310615 A1
(43) Pub. Date: Oct. 10, 2019

(54) METHOD AND SYSTEM FOR TRANSPORTING ORDER

(71) Applicant: HKC Corporation Limited, Shenzhen, Guangdong (CN)

(72) Inventor: Jianfeng Shan, Shenzhen, Guangdong (CN)

(21) Appl. No.: 16/461,368

(22) PCT Filed: Dec. 20, 2017
(86) PCT No.: PCT/CN2017/117323

§ 371 Date: May 16, 2019

(30) Foreign Application Priority Data
Sep. 25, 2017 (CN) 201710874401.3

(51) Int. Cl. G05B 19/418

(52) U.S. Cl. CPC G05B 19/41865; G05B 2219/32252; G05B 19/4189

(57) ABSTRACT

Disclosed are a method and a system for transporting order. The method for transporting order includes: marking an ordering priority level of the working machine previously; identifying a priority ordering machine when several working machines issue orders at the same time; determining whether a transporting characteristic information of the priority ordering machine meets the preset condition for triggering a priority order; and if yes, priority ordering the priority ordering machine.

### TECHNICAL FIELD

The present disclosure relates to the field of automated material processing technology, and more particularly relates to a method and a system for transporting order.

### BACKGROUND

In an exemplary technology, when a manufacturing execution system (MES) gives a product-delivering instruction to a material control system (MCS), orders are made according to the demand signal sent by the machines. MES cannot make good decision when the important machines and the non-important machines simultaneously demand the product, resulting in loss of capacity. It is especially obvious when the production is close to full load or the product is in short supply but in great demand. At this time, it can only be handled by personnel, but it cannot be handled best because of the difference in experience and judgment of the personnel.

### SUMMARY

The present disclosure provides a method for transporting order, which can avoid an idling state (Idle) of an important machine and improve production efficiency.

In one aspect, the embodiment of the present disclosure provides a method for transporting order includes the following operations: marking an ordering priority level of the working machine previously; identifying a priority ordering machine when a plurality of working machines issue orders at the same time; determining whether a transporting characteristic information of the priority ordering machine meets the preset condition for triggering a priority order; and if yes, priority ordering the priority ordering machine.

On the other hand, the embodiment of the present disclosure provides another method for transporting order includes the following operations: marking an ordering priority level of the working machine previously; identifying a priority ordering machine when a plurality of working machines issue orders at the same time; acquiring a remaining time of the priority ordering machine from being idleness; acquiring a time duration required for transporting a product to the priority ordering machine; determining whether the remaining time from being idleness of the machine exceeds the time duration required for the transporting; in the case that the remaining time from being idleness of the machine is less than the time duration required for transporting, and there is no product waiting for ordering, determining whether there is an ordered product already in transportation; if yes, identifying the priority level of the machine that corresponding to the product in transportation; reassigning the product in transportation corresponding to the machine with the lowest priority; and transporting the reassigned product to the priority ordering machine.

In another aspect, the embodiment of the present disclosure provides a system for transporting order, the system includes: a marking module, being configured to mark an ordering priority level of the working machine previously; a first identifying module, being configured to identify a priority ordering machine when a plurality of working machines issue orders at the same time; a first determining module, being configured to determine whether a transporting characteristic information of the priority ordering machine meets the preset condition for triggering a priority order; and a first implementing module, being configured to priority ordering the priority ordering machine, if yes, implementing module.

The method and system for transporting order in the exemplary embodiment of the present disclosure, by marking an ordering priority level of the working machine previously, identifying a priority ordering machine when several working machines issue orders at the same time, determining whether a transporting characteristic information of the priority ordering machine meets the preset condition for triggering a priority order, and if yes, priority ordering the priority ordering machine, the important machine is always in the working state. This disclosure solves the technical problem in the prior art that the Idle phenomenon occurs on the important machine, to avoid the loss of capacity caused by the ordering problem, and thereby improving production efficiency.

### BRIEF DESCRIPTION OF THE ACCOMPANYING DRAWINGS

To better illustrate the technical solutions that are reflected in various embodiments according to this disclosure or that are found in the prior art, the accompanying drawings intended for the description of the embodiments herein or for the prior art will now be briefly described, it is evident that the accompanying drawings listed in the following description show merely some embodiments according to this disclosure, and that those having ordinary skill in the art will be able to obtain other drawings based on the arrangements shown in these drawings without making inventive efforts.

FIG. 1 is an illustrative flowchart of a first embodiment of a method for transporting order in accordance with this disclosure;

FIG. 2 is an illustrative flowchart of a second embodiment of a method for transporting order in accordance with this disclosure;

FIG. 3 is an illustrative flowchart of a third embodiment of a method for transporting order in accordance with this disclosure;

FIG. 4 is an illustrative block diagram of a first embodiment of a system for transporting order in accordance with this disclosure;

FIG. 5 is an illustrative block diagram of a second embodiment of a system for transporting order in accordance with this disclosure;

FIG. 6 is an illustrative block diagram of a third embodiment of a system for transporting order in accordance with this disclosure.

### DETAILED DESCRIPTION OF ILLUSTRATIVE EMBODIMENTS

Various technical solutions in the embodiments of this disclosure will now be described clearly and completely in the following in connection with drawings of illustrative embodiments. It is obvious that the described embodiments are a part of the embodiments of this disclosure, and not all of the embodiments. All other embodiments obtained by a person skilled in the art based on the embodiments of this disclosure without creative work fall into the scope of this disclosure.

The terms “comprise” and “include”, when used in the specification and the claims of this disclosure, indicating the presence of the described features, wholes, steps, operations, elements and/or components. However, the existence or addition of one or more other features, wholes, steps, operations, elements and/or components thereof are not excluded.

It is also appreciated that the terms used herein is for the purpose of describing particular embodiments and is not intended to be limiting it. As used in the specification and the attached claims of this disclosure, the singular terms “a”, “one” and “this” are intended to include the plural unless the context clearly specifies otherwise.

As used in the specification and the attached claims, the term “if” can be interpreted as “when” or “once” or “in response to determining” or “in response to detecting” depending on the context. Similarly, the phrase “if determined” or “if detected [condition or event described]” may be interpreted in context to mean “once determined” or “in response to detecting [condition or event described]” or “once detected [the described condition or event]” or “in response to determining”.

It should also be understood that although the terms “first”, “second”, etc. may be used herein to describe various elements, these elements should not be limited to these terms. These terms are only used to distinguish these elements from each other. For example, a first terminal may be referred to as a second terminal without departing from the scope of this disclosure, and similarly, a second terminal may be referred to as a first terminal. The first terminal and the second terminal are both terminals, but they are not the same terminal.

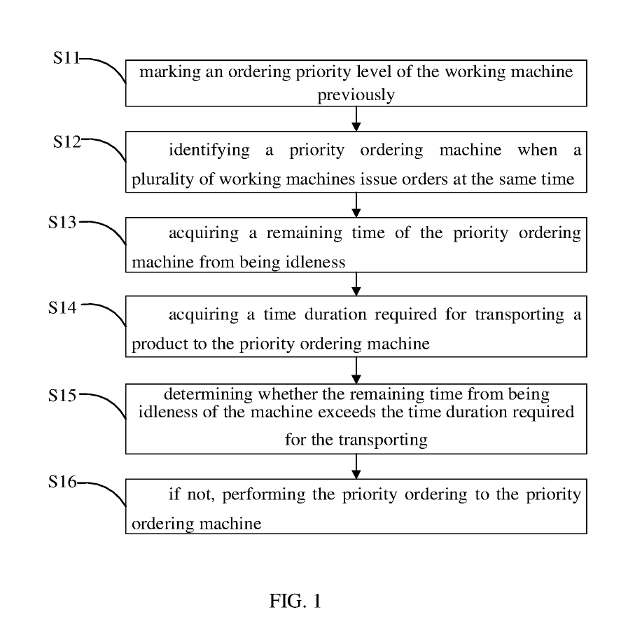

As illustrated in FIG. 1, an illustrative flowchart of a first embodiment of a method for transporting order in accordance with this disclosure, the method includes the following operations S11 to S16.

In S11, marking an ordering priority level of the working machine previously.

Specifically, before the system starts to operate, the priority level is made on each machine that participates in the work, that is, to determine certain machines as the priority ordering machine, and to carry out the ordering operation on the priority ordering machine when the ordering instruction is given at the same time.

In S12, identifying a priority ordering machine when a plurality of working machines issue orders at the same time.

Specifically, when multiple working machines issue an ordering instruction at the same time, the priority of each working machine is identified and the working machine marked as the highest priority is identified.

In S13, acquiring a remaining time of the priority ordering machine from being idleness.

Specifically, when the machine with the highest priority is identified, the remaining time period for the priority ordering machine with the highest priority from being idleness is obtained, that is, the time period required for the machine with the highest priority to complete the product currently processing on the machine.

In S14, acquiring a time duration required for transporting a product to the priority ordering machine.

Specifically, after the machine with the highest priority order is identified, the time required for delivering the product to the highest priority ordering machine is obtained. That is, after receiving the order, the time required for the handling equipment to carry the product to the highest priority ordering machine.

In S15, determining whether the remaining time from being idleness of the machine exceeds the time duration required for the transporting.

Specifically, it is determined whether the remaining time period from being idleness of the machine exceeds the time period required for transporting. That is, it is judged whether the time period required for the machine with the highest priority to complete the product currently processing on the machine is longer than the time period required for handling the product to the highest priority order machine.

In S16, if not, performing the priority ordering to the priority ordering machine.

Specifically, if the remaining time period from being idleness of the machine is no more than the time period required for transporting a product to the priority ordering machine, the highest priority ordering machine is preferentially processing order. Once the product is ready to be transported by the delivering equipment, whether or not the order from other machines is received, the order of the highest priority ordering machine is taken as the first instruction, and the delivering equipment carries the product to the highest priority machine preferentially.

Specifically, by presetting the priority of the work machine, the order instructions of the important work machine can be preferentially adopted, making the important work machine be in the working state to the greatest extent, avoid the phenomenon of the important machine being idleness, preventing the loss of capacity caused by the order problem, and improve the production efficiency.

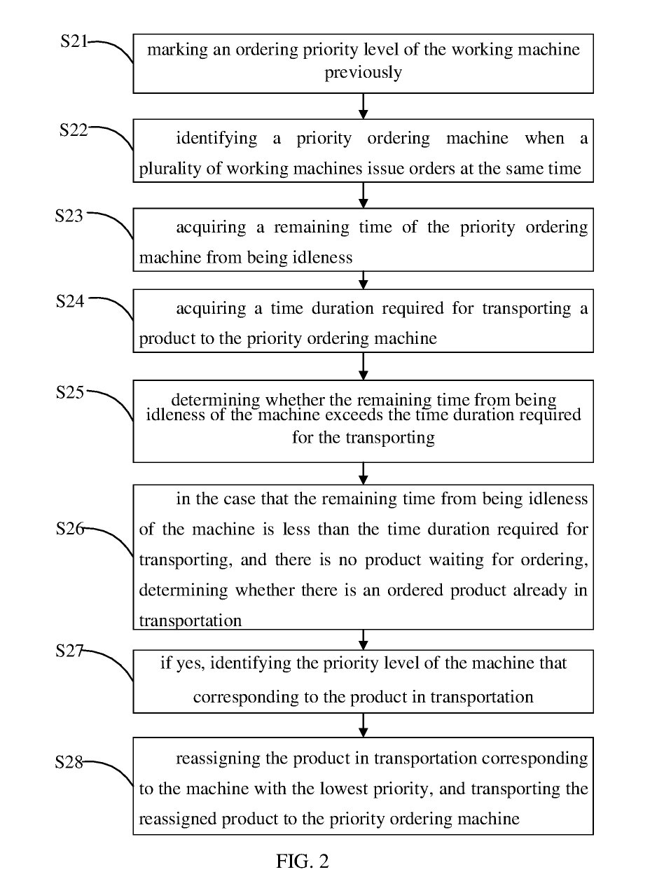

As illustrated in FIG. 2, an illustrative flowchart of a second embodiment of a method for transporting order in accordance with this disclosure, the method includes the following options S21 to S28.

In S21, marking an ordering priority level of the working machine previously.

Specifically, before the system starts to operate, the priority level is made on each machine that participates in the work, that is, to determine certain machines as the priority ordering machine, and to carry out the ordering operation on the priority ordering machine when the ordering instruction is given at the same time.

In S22, identifying a priority ordering machine when a plurality of working machines issue orders at the same time.

Specifically, when multiple working machines issue an ordering instruction at the same time, the priority of each working machine is identified and the working machine marked as the highest priority is identified.

In S23, acquiring a remaining time of the priority ordering machine from being idleness.

Specifically, when the machine with the highest priority is identified, the remaining time period for the priority ordering machine with the highest priority from being idleness is obtained, that is, the time period required for the machine with the highest priority to complete the product currently processing on the machine.

In S24, acquiring a time duration required for transporting a product to the priority ordering machine.

Specifically, after the machine with the highest priority order is identified, the time required for delivering the product to the highest priority ordering machine is obtained. That is, after receiving the order, the time required for the handling equipment to carry the product to the highest priority ordering machine.

In S25, determining whether the remaining time from being idleness of the machine exceeds the time duration required for the transporting.

Specifically, it is determined whether the remaining time period from being idleness of the machine exceeds the time period required for transporting. That is, it is judged whether the time period required for the machine with the highest priority to complete the product currently processing on the machine is longer than the time period required for handling the product to the highest priority order machine.

In S26, in the case that the remaining time from being idleness of the machine is less than the time duration required for transporting, and there is no product waiting for ordering, determining whether there is an ordered product already in transportation.

Specifically, when the remaining time period from being idleness of the machine is less than the time period required for transporting, but there is idle product waiting for being transported at the ordering station, it is judged whether or not the product is being transportation on the way. Because after each work machine issues an order, it takes one transportation time to handle the order, though some products have not been delivered.

In S27, if yes, identifying the priority level of the machine that corresponding to the product in transportation.

Specifically, if there are products that are still in transit, the machines that are to be delivered corresponding to the products are distinguished, and the priorities of the working machines are identified. That is, identifying the initial setting priority order of these working machines.

In S28, reassigning the product in transportation corresponding to the machine with the lowest priority, and transporting the reassigned product to the priority ordering machine.

Specifically, after the work machines corresponding to the products in the transportation are distinguished, identify the priority of these work machines, find the work machine with the lowest priority, and reassign the products in the transporting process corresponding to the machine. That is, change the delivery task and send this product to the priority order machine.

Specifically, by reassigning the product corresponding to the work machine with the lowest priority in transit, it is possible to extend the time that the important machine can continue to work, and avoid the economic losses of the important machine when the product supply is insufficient, which increase production efficiency.

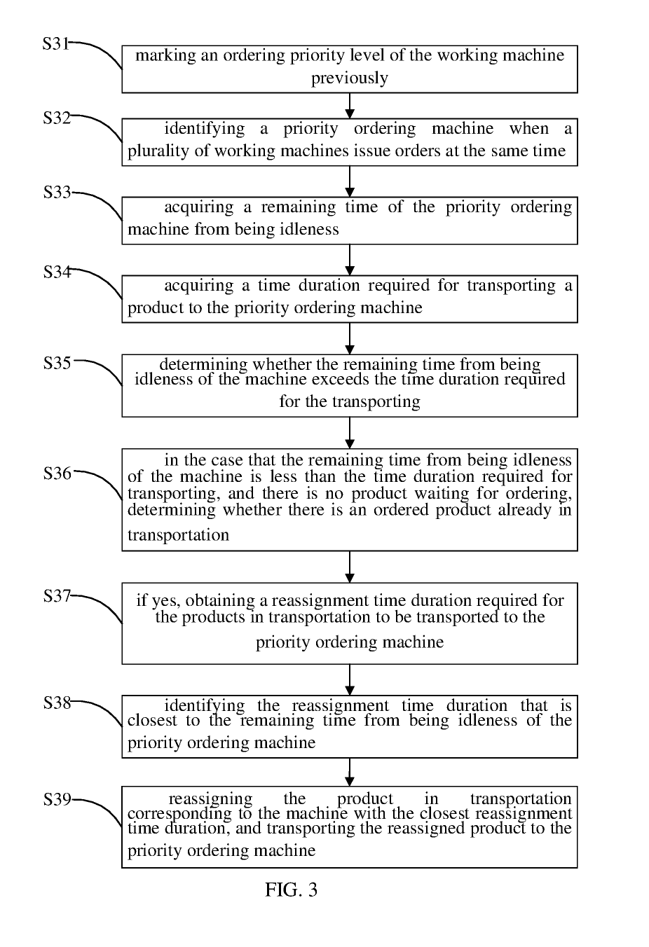

As illustrated in FIG. 3, an illustrative flowchart of a third embodiment of a method for transporting order in accordance with this disclosure, the method includes the following options S31 to S39.

In S31, marking an ordering priority level of the working machine previously.

Specifically, before the system starts to operate, the priority level is made on each machine that participates in the work, that is, to determine certain machines as the priority ordering machine, and to carry out the ordering operation on the priority ordering machine when the ordering instruction is given at the same time.

In S32, identifying a priority ordering machine when a plurality of working machines issue orders at the same time.

Specifically, when multiple working machines issue an ordering instruction at the same time, the priority of each working machine is identified and the working machine marked as the highest priority is identified.

In S33, acquiring a remaining time of the priority ordering machine from being idleness.

Specifically, when the machine with the highest priority is identified, the remaining time period for the priority ordering machine with the highest priority from being idleness is obtained, that is, the time period required for the machine with the highest priority to complete the product currently processing on the machine.

In S34, acquiring a time duration required for transporting a product to the priority ordering machine.

Specifically, after the machine with the highest priority order is identified, the time required for delivering the product to the highest priority ordering machine is obtained. That is, after receiving the order, the time required for the handling equipment to carry the product to the highest priority ordering machine.

In S35, determining whether the remaining time from being idleness of the machine exceeds the time duration required for the transporting.

Specifically, it is determined whether the remaining time period from being idleness of the machine exceeds the time period required for transporting. That is, it is judged whether the time period required for the machine with the highest priority to complete the product currently processing on the machine is longer than the time period required for handling the product to the highest priority order machine.

In S36, in the case that the remaining time from being idleness of the machine is less than the time duration required for transporting, and there is no product waiting for ordering, determining whether there is an ordered product already in transportation.

Specifically, when the remaining time period from being idleness of the machine is less than the time period required for transporting, but there is idle product waiting for being transported at the ordering station, it is judged whether or not the product is being transportation on the way. Because after each work machine issues an order, it takes one transportation time to handle the order, though some products have not been delivered.

In S37, if yes, obtaining a reassignment time duration required for the products in transportation to be transported to the priority ordering machine.

Specifically, if there are products that are still in transit, identifying the reassignment time periods are required for the products to be transported to the priority ordering machine, to get the delivery time length corresponding to each group of products in transit.

In S38, identifying the reassignment time duration that is closest to the remaining time from being idleness of the priority ordering machine.

Specifically, the reassignment time period corresponding to each group of products in the process of moving is identified, which is closest to the remaining time period for the priority ordering machine from being idleness.

In S39, reassigning the product in transportation corresponding to the machine with the closest reassignment time duration, and transporting the reassigned product to the priority ordering machine.

Specifically, after identifying the reassignment time period that is closest to the remaining time period for the priority ordering machine from being idleness for each group of products in transit, rewrite the moving information of this group of products and change the moving target of this group of products to priority ordering machine.

Specifically, by reassigning the product corresponding to the work machine with the closest remaining time period, it is possible to minimize critical machine work intervals, extend the time that the important machine can continue to work, and avoid the economic losses of the important machine when the product supply is insufficient, which increase production efficiency.

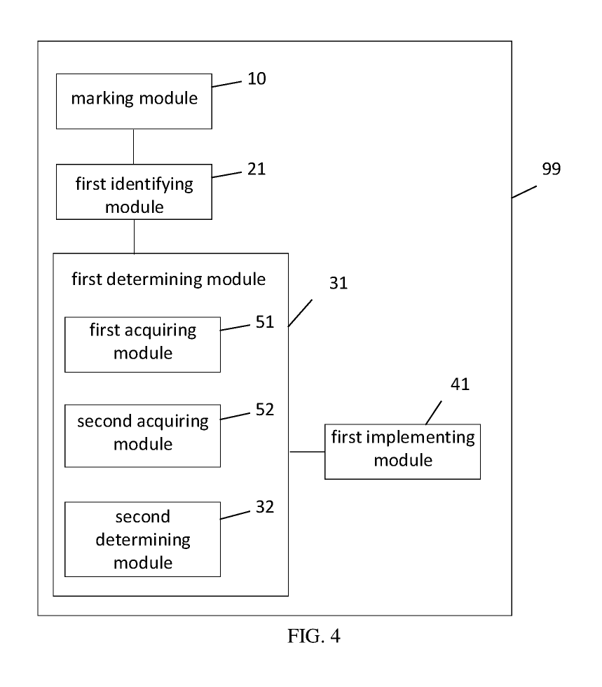

As illustrated in FIG. 4, an illustrative block diagram of a first embodiment of a system for transporting order in accordance with this disclosure, the system includes the following modules.

A marking module 10, being configured to mark an ordering priority level of the working machine previously.

A first identifying module 21, being configured to identify a priority ordering machine when a plurality of working machines issue orders at the same time.

A first determining module 31, being configured to determine whether a transporting characteristic information of the priority ordering machine meets the preset condition for triggering a priority order, includes a first acquiring module 51, a second determining module 52, and a second determining module 32.

A first acquiring module 51, being configured to remaining time of the priority ordering machine from being idleness.

A second acquiring module 52, being configured to acquire a time duration required for transporting a product to the priority ordering machine.

A second determining module 32, being configured to determine whether the remaining time from being idleness of the machine exceeds the time duration required for the transporting.

A first implementing module 41, being configured to perform the priority ordering to the priority ordering machine if the remaining time from being idleness of the priority ordering machine does not exceed the time duration required for transporting.

Specifically, the system 99 pre-marks the order priority of the working machine through the marking module 10. When the plurality of working machines issue the ordering instruction in the same period, the first identifying module 21 will identify the priority ordering machine. The first acquiring module 51 starts to acquire the remaining time period for the priority ordering machine from being idleness, and the second acquiring module 52 starts to acquire the time period required for transporting a product to the priority ordering machine, and judges the machine through the second determining module 32, that whether the remaining time period from being idleness of the machine exceeds the time period required for transporting. And if the remaining time period for the priority ordering machine from being idleness does not exceed the time period required for transporting a product to the priority ordering machine, the first implementing module 41 preferentially perform the priority ordering to the priority ordering machine.

Specifically, by presetting the priority of the work machine, the order instructions of the important work machine can be preferentially adopted, making the important work machine be in the working state to the greatest extent, avoid the phenomenon of the important machine being idleness, preventing the loss of capacity caused by the order problem, and improve the production efficiency.

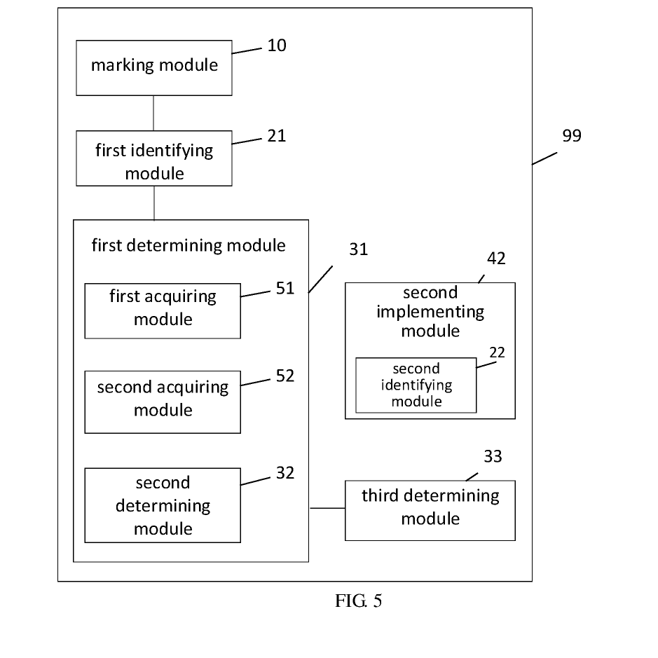

As illustrated in FIG. 5, an illustrative block diagram of a second embodiment of a system for transporting order in accordance with this disclosure, the system includes the following modules.

A marking module 10, being configured to mark an ordering priority level of the working machine previously.

A first identifying module 21, being configured to identify a priority ordering machine when a plurality of working machines issue orders at the same time.

A first determining module 31, being configured to determine whether a transporting characteristic information of the priority ordering machine meets the preset condition for triggering a priority order, includes a first acquiring module 51, a second determining module 52, and a second determining module 32.

A first acquiring module 51, being configured to acquire a remaining time of the priority ordering machine from being idleness.

A second acquiring module 52, being configured to acquire a time duration required for transporting a product to the priority ordering machine.

A second determining module 32, being configured to determine whether the remaining time from being idleness of the machine exceeds the time duration required for the transporting.

A third determining module 33, being configured to determine whether there is an ordered product already in transportation, in the case that the remaining time from being idleness of the machine is less than the time duration required for transporting, and there is no product waiting for ordering.

A second implementing module 42, being configured to reassign the product in transportation, and transport the reassigned product to the priority ordering machine, if there is a product already in transportation, includes a second identifying module 22.

A second identifying module 22, being configured to identify the priority level of the machine that corresponding to the product in transportation.

The second implementing module 42 is configured to reassign the product in transportation corresponding to the machine with the lowest priority.

Specifically, the system 99 pre-marks the order priority of the working machine through the marking module 10. When the plurality of working machines issue the ordering instruction in the same period, the first identifying module 21 will identify the priority ordering machine. The first acquiring module 51 starts to acquire the remaining time period for the priority ordering machine from being idleness, and the second acquiring module 52 starts to acquire the time period required for transporting a product to the priority ordering machine, and judges the machine through the second determining module 32, that whether the remaining time period from being idleness of the machine exceeds the time period required for transporting.

And if the remaining time period for the priority ordering machine from being idleness does not exceed the time period required for transporting a product to the priority ordering machine, and there is no product waiting for the order, the third determining module 33 will determine there is an ordered product in transportation. If yes, the second identification module 22 identifies the priority level of the machine that corresponding to the product in transportation, and the second implementing module 42 performs reassign the product to machine with the lowest priority.

Specifically, by reassigning the product corresponding to the work machine with the lowest priority in transit, it is possible to extend the time that the important machine can continue to work, and avoid the economic losses of the important machine when the product supply is insufficient, which increase production efficiency.

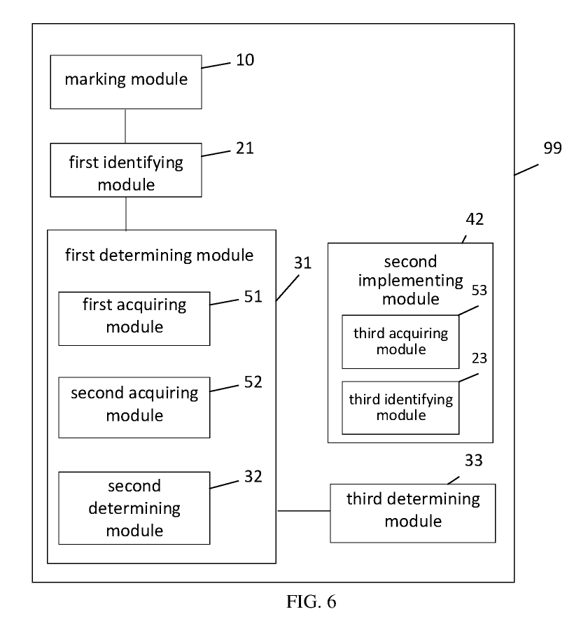

As illustrated in FIG. 6, an illustrative block diagram of a third embodiment of a system for transporting order in accordance with this disclosure, the system includes the following modules.

A marking module 10, being configured to mark an ordering priority level of the working machine previously.

A first identifying module 21, being configured to identify a priority ordering machine when a plurality of working machines issue orders at the same time.

A first determining module 31, being configured to determine whether a transporting characteristic information of the priority ordering machine meets the preset condition for triggering a priority order, includes a first acquiring module 51, a second determining module 52, and a second determining module 32.

A first acquiring module 51, being configured to acquire a remaining time of the priority ordering machine from being idleness.

A second acquiring module 52, being configured to acquire a time duration required for transporting a product to the priority ordering machine.

A second determining module 32, being configured to determine whether the remaining time from being idleness of the machine exceeds the time duration required for the transporting.

A third determining module 33, being configured to determine whether there is an ordered product already in transportation, in the case that the remaining time from being idleness of the machine is less than the time duration required for transporting, and there is no product waiting for ordering.

A second implementing module 42, being configured to reassign the product in transportation, and transport the reassigned product to the priority ordering machine, if there is a product already in transportation, includes a third acquiring module 53 and a third identifying module 23.

A third acquiring module 53, being configured to obtain a reassignment time duration required for the products in transportation to be transported to the priority ordering machine.

A third identifying module 23, being configured to identify the reassignment time duration that is closest to the remaining time from being idleness of the priority ordering machine.

The second implementing module 42 is configured to reassign the product in transportation corresponding to the machine with the closest reassignment time duration.

Specifically, the system 99 pre-marks the order priority of the working machine through the marking module 10. When the plurality of working machines issue the ordering instruction in the same period, the first identifying module 21 will identify the priority ordering machine. The first acquiring module 51 starts to acquire the remaining time period for the priority ordering machine from being idleness, and the second acquiring module 52 starts to acquire the time period required for transporting a product to the priority ordering machine, and judges the machine through the second determining module 32, that whether the remaining time period from being idleness of the machine exceeds the time period required for transporting.

And if the remaining time period for the priority ordering machine from being idleness does not exceed the time period required for transporting a product to the priority ordering machine, and there is no product waiting for the order, the third determining module 33 will determine there is an ordered product in transportation. If yes, the third acquiring module 53 obtains reassignment time periods required for the products in transportation to be transported to the priority ordering machine, third identifying module 23 identifies the reassignment time period that is closest to the remaining time period from being idleness of the priority ordering machine, and the second implementing module 42 performs reassign the product to machine with the closest reassignment time period.

Specifically, by reassigning the product corresponding to the work machine with the closest remaining time period, it is possible to minimize critical machine work intervals, extend the time that the important machine can continue to work, and avoid the economic losses of the important machine when the product supply is insufficient, which increase production efficiency.

Specifically, the method for transporting the order and the system for transporting the order can be used to carry the display panel or other electronic products, and the display panel can be, for example, a liquid crystal display panel, an OLED display panel, a QLED display panel, a curved display panel or other display panel.

In the above embodiments provided in this disclosure, it should be understood that the disclosed methods are merely illustrative and may be implemented in other manners.

It should be noted that the operations in the embodiments of this disclosure, may be sequentially adjusted, merged, and deleted according to actual needs.

The units in the terminal of the embodiments of this disclosure may be combined, divided, and deleted according to actual needs.

The foregoing description merely portrays some illustrative embodiments according to the disclosure and therefore is not intended to limit the patentable scope of the disclosure. Any equivalent structural or flow transformations that are made taking advantage of the specification and accompanying drawings of the disclosure and any direct or indirect applications thereof in other related technical fields shall all fall in the scope of protection of the disclosure. Therefore, the scope of protection of this disclosure shall be subject to the claims.

1. A method for transporting order, wherein the method comprises:
marking an ordering priority level of the working machine previously;
identifying a priority ordering machine when a plurality of working machines issue orders at the same time;
determining whether a transporting characteristic information of the priority ordering machine meets the preset condition for triggering a priority order; and
if yes, priority ordering the priority ordering machine.

2. The method of claim 1, wherein the operation of determining whether a transporting characteristic information of the priority ordering machine meets the preset condition for triggering a priority order comprises:
acquiring a remaining time of the priority ordering machine from being idleness;
acquiring a time duration required for transporting a product to the priority ordering machine;
determining whether the remaining time from being idleness of the machine exceeds the time duration required for the transporting; and
if not, performing the priority ordering to the priority ordering machine.

3. The method of claim 2, wherein the operation of performing the priority ordering to the priority ordering machine comprises:
identifying a priority level of the priority ordering machines, when received orders from a plurality of priority machines at the same time; and
taking an order instruction from the priority machine with the highest priority as a first instruction.

4. The method of claim 2, wherein the method further comprises:
in the case that the remaining time from being idleness of the machine is less than the time duration required for transporting, and there is no product waiting for ordering, determining whether there is an ordered product already in transportation; and
if yes, reassigning the product in transportation, and transporting the reassigned product to the priority ordering machine.

5. The method of claim 4, wherein the operation of reassigning the product in transportation comprises:
terminating the current transporting action; and
generating an instruction of transporting the reassigned product to the priority ordering machine.

6. The method of claim 4, wherein the operation of reassigning the product in transportation comprises:
identifying the priority level of the machine that corresponding to the product in transportation; and
reassigning the product in transportation corresponding to the machine with the lowest priority.

7. The method of claim 4, wherein the operation of reassigning the product in transportation comprises:
obtaining a reassignment time duration required for the products in transportation to be transported to the priority ordering machine;
identifying the reassignment time duration that is closest to the remaining time from being idleness of the priority ordering machine; and
reassigning the product in transportation corresponding to the machine with the closest reassignment time duration.

8. The method of claim 7, wherein the operation of reassigning the product in transportation corresponding to the machine with the closest reassignment time duration comprises:
changing the transportation target of the product corresponding to the machine with the closest reassignment time duration to the priority ordering machine.

9. The method of claim 4, wherein the operation of reassigning the product in transportation comprises:
identifying the priority level of the machine that corresponding to the product in transportation;
obtaining reassignment time required for the products in transportation to be transported to the priority ordering machine; and
reassigning the product in transportation with the shortest reassignment time as well as corresponding to the machine with the lowest priority.

10. A method for transporting order, wherein the method comprises:
marking an ordering priority level of the working machine previously;
identifying a priority ordering machine when a plurality of working machines issue orders at the same time;
acquiring a remaining time of the priority ordering machine from being idleness;
acquiring a time duration required for transporting a product to the priority ordering machine;
determining whether the remaining time from being idleness of the machine exceeds the time duration required for the transporting;
in the case that the remaining time from being idleness of the machine is less than the time duration required for transporting, and there is no product waiting for ordering, determining whether there is an ordered product already in transportation;
if yes, identifying the priority level of the machine that corresponding to the product in transportation;
reassigning the product in transportation corresponding to the machine with the lowest priority; and
transporting the reassigned product to the priority ordering machine.

11. The method of claim 10, wherein the operation of identifying a priority ordering machine comprises:
identifying a priority level of the priority ordering machines, when received orders from a plurality of priority machines at the same time; and
taking an order instruction from the priority machine with the highest priority as a first instruction.

12. The method of claim 10, wherein the operation of reassigning the product to machine with the lowest priority comprises:
terminating the current transporting action; and
generating an instruction of transporting the reassigned product to the priority ordering machine.

13. The method of claim 10, further comprises, subsequent to the operation of identifying the priority level of the machine that corresponding to the product in transportation:
obtaining a reassignment time duration required for the products in transportation to be transported to the priority ordering machine; and
reassigning the product in transportation with the shortest reassignment time as well as corresponding to the machine with the lowest priority.

14. A system for transporting order, wherein the system comprises:
a marking module, being configured to mark an ordering priority level of the working machine previously;
a first identifying module, being configured to identify a priority ordering machine when a plurality of working machines issue orders at the same time;
a first determining module, being configured to determine whether a transporting characteristic information of the priority ordering machine meets the preset condition for triggering a priority order; and
a first implementing module, being configured to priority ordering the priority ordering machine, if the transporting characteristic information of the priority ordering machine meets the preset condition for triggering a priority order.

15. The system of claim 14, wherein the first determining module that is configured to determine whether a transporting characteristic information of the priority ordering machine meets the preset condition for triggering a priority order comprises:
a first acquiring module, being configured to acquire a remaining time of the priority ordering machine from being idleness;
a second acquiring module, being configured to acquire a time duration required for transporting a product to the priority ordering machine;
a second determining module, being configured to determine whether the remaining time from being idleness of the machine exceeds the time duration required for the transporting; and
the first implementing module is configured to perform the priority ordering to the priority ordering machine if the remaining time from being idleness of the priority ordering machine does not exceed the time duration required for transporting.

16. The system of claim 15, wherein the operation of the first implementing module performing the priority ordering to the priority ordering machine comprises:
identifying a priority level of the priority ordering machines, when received orders from a plurality of priority machines at the same time; and
taking an order instruction from the priority machine with the highest priority as a first instruction.

17. The system of claim 15, wherein further comprises:
a third determining module, being configured to determine whether there is an ordered product already in transportation, in the case that the remaining time from being idleness of the machine is less than the time duration required for transporting, and there is no product waiting for ordering; and
a second implementing module, being configured to reassign the product in transportation, and transport the reassigned product to the priority ordering machine, if there is a product already in transportation.

18. The system of claim 17, wherein the operation of the second implementing module reassigning the product in transportation comprises:
terminating the current transporting action; and
generating an instruction of transporting the reassigned product to the priority ordering machine.

19. The system of claim 17, wherein the second implementing module that reassign the product in the transportation comprises:
a second identifying module, being configured to identify the priority level of the machine that corresponding to the product in transportation; and
the second implementing module is configured to reassign the product in transportation corresponding to the machine with the lowest priority.

20. The system of claim 17, wherein the operation of the second implementing module that reassign the product in transportation comprises:
identifying the priority level of the machine that corresponding to the product in transportation;
obtaining reassignment time periods required for the products in transportation to be transported to the priority ordering machine; and
the second implementing module is configured to perform reassigning the product in transportation with the shortest reassignment time as well as corresponding to the machine with the lowest priority.
